(19) United States
(12) Patent Application Publication
(10) Pub. No.: US 2011/0119634 A1
(43) Pub. Date: May 19, 2011

(54) GLOBAL VIEW FOR DIGITAL ASSETS

(75) Inventors: Nikhil Bhatt, Cupertino, CA (US); Alexander David Wallace, Sunnyvale, CA (US); Mark Lee Kawano, San Mateo, CA (US)

(73) Assignee: APPLE INC., Cupertino, CA (US)

(21) Appl. No.: 12/619,634

(22) Filed: Nov. 16, 2009

(51) Int. Cl. G06F 3/048

(52) U.S. Cl. 715/854

(57) ABSTRACT

Processes and systems are presented, for generating and displaying a flat all-projects view of a library of digital assets. In one aspect, a process includes receiving input from a user of the application requesting to view content accessible by the application. The accessible content can include a plurality of digital assets, folders and projects stored in a hierarchy accessed by the application, and each project represents a user-defined set of digital assets. All projects residing at any location within the hierarchy can be identified, and a flat view of all identified projects can be presented.

### BACKGROUND

This specification relates generally to browsing large sets of digital assets, and more specifically to generating and displaying a global view of a library of digital assets.

Digital assets can include media items and other types of electronic documents. For instance, a media item can be a digital image. Further, the digital image may be either an individual still image or a frame of a movie. Additionally, a digital asset can include spreadsheets, word processing documents, and portable document format (PDF) documents.

Moreover, digital assets such as individual items of media content (e.g., digital images) and containers for such items (e.g., folders, projects, etc.) typically are arranged and stored in a digital library having multiple hierarchical levels. A typical hierarchy of the library of digital assets can have various hierarchy levels and sub-levels, such as folders nested within other folders. If the library of digital assets corresponds to a database, then the foregoing hierarchy represents a logical hierarchy. However, if the library of digital assets corresponds to a file system on a storage device, the hierarchy described above represents a directory tree on the storage disk.

Typically, a user that desires to navigate through such a hierarchical library of digital assets, for example, to access items of media content, can use one of two different tools: When traversing the file system hierarchy, the user can use a file system explorer utility that is built-into the operating system (Windows® available from Microsoft, of Redmond, Wash.). However, an application (e.g., iPhoto® software available from Apple, of Cupertino, Calif.) designed to manage items of a specific media type can be used to browse the logical hierarchy of a digital asset database. Either of these tools can be configured to expose the library hierarchy to the user (e.g., in a portion of the user interface) as the user navigates through the various hierarchical levels.

### SUMMARY

This specification discloses processes and systems for generating and displaying a flat global view (also referred to as an “all projects view”) of a library of digital assets that are arranged and stored across multiple hierarchical levels.

In general, one aspect of the subject matter described in this specification can be implemented in processes performed by an application executing on a computer system, and that include the actions of receiving input from a user of the application requesting to view content accessible by the application. The accessible content can include a plurality of digital assets, folders and projects stored in a hierarchy accessed by the application. Each project can represent a user-defined set of digital assets. All projects residing at any location within the hierarchy can be identified, and a flat view of all identified projects can be presented.

If the content accessible by the application is stored in a database in accordance with a logical hierarchy, the flat view of all the identified projects contained in the database can be presented. Additionally, if the content accessible by the application is stored in a file system in accordance with a directory-tree hierarchy, the presented flat view can include all identified projects contained in the file system. In some implementations, the application can generate both a database-all-projects-view and a disk-all-projects view, for example.

These and other implementations can include one or more of the following features. The flat view can include all identified projects arranged in alphabetical order. Additionally, the flat view can contain all identified projects grouped into respective folder associations. Further, the flat view can include all identified projects grouped into respective date associations. The input received from the user can specify a particular location within the hierarchy and the presented flat view can include only those projects at or below that particular location within the hierarchy.

According to another aspect, the described subject matter can also be implemented in a computer readable medium encoded with a computer program. The program includes instructions that when executed by a processor of a computing device cause the processor to perform operations including accessing a media library that contains digital images, projects and folders. The digital images are uniquely stored in associated projects. Further, the folders and the projects are stored according to a hierarchy of the media library. Input selecting a hierarchy level of the media library can be received from a user of the computer program. A flat graphical representation of all projects stored at or below the selected hierarchy level can be generated and presented to the user.

These and other implementations can include one or more of the following features. The computer program instructions, when executed prior to presenting the flat graphical representation, can cause the processor to perform further operations receiving from the user a grouping criterion. The projects at or below the selected hierarchy level can be grouped based on the received grouping criterion. In some implementations, the received grouping criterion can be a calendar interval. The calendar interval corresponding to a project starts on an acquisition date of a first acquired digital image of the project and ends at an acquisition date of a last acquired digital image of the project. The computer program instructions, when executed to perform the grouping, can cause the processor to perform further operations including generating a group of projects labeled by year to include projects that have calendar ranges contained within the year. Additionally, a group of projects labeled by a range of years can be generated to include projects that have calendar intervals extending over the range of years. In some implementations, the received grouping criterion can be a hierarchy sublevel of the media library. The computer program instructions, when executed to perform the grouping, can cause the processor to generate a group of projects to include all projects contained at or below the hierarchy sublevel. The hierarchical sublevel can be a folder of the media library. The computer program instructions when executed can cause the processor to label the generated group of projects in accordance with a folder's name.

According to another aspect, the described subject matter can also be implemented in a system including a storage device for storing a library of digital assets. The system also includes a computing device communicatively coupled with the storage device. The computing device executes an application that is configured to perform operations including retrieving from the storing device the library of digital assets. The library of digital assets stores digital assets in corresponding projects. Further, the folders and the projects are stored according to a hierarchy of the library of digital assets. A selection of a hierarchy level of the retrieved library of digital assets can be received from a user of the system. Additionally, a grouping criterion can be received from the user. Groups of projects can be created based on the received grouping criterion. A flat all-projects-view can be displayed including the created groups of projects stored at or below the selected hierarchy level.

These and other implementations can include one or more of the following features. The received grouping criterion can include a calendar interval. A calendar interval corresponding to a project starts on a date when a first digital asset of the project is created, and ends on a date when a last digital asset of the project is created. To create the group of projects, the application is configured to generate a group of projects labeled by a predetermined calendar range to include projects that have calendar intervals contained within the predetermined calendar range. After displaying the flat all-projects-view, the application is further configured to receive input selecting another hierarchical level of the library of digital assets that is lower than the selected hierarchical level. The application includes a graphical user interface that can include an input control, for example, a menu item, a label, or a button. The application is configured to receive from a user input selecting the hierarchical level of the library of digital assets via the input control of the user interface.

According to another aspect, the described subject matter can also be implemented in a method including receiving input from a user of an application executing on a computer system to view a plurality of file system objects accessible by the application. The plurality of file system objects includes files, folders and pointers stored according to a hierarchy of the file system. Further input selecting first and second hierarchy levels of the file system can be received from the user. All folders stored between the first and second hierarchy levels can be identified. Then, a flat view of all the identified folders can be presented. In some implementations, the selected second hierarchy level of the file system represents a root level of the file system. Thus, the flat view of all folders contained in the file system above the first selected level can be depicted at the root level of the file system.

In some implementations, the files represent digital images, and the file system represents a library including the digital images. If the folders which are stored at the first selected hierarchy level represent projects and consist of one or more files, then the method further includes presenting a flat all-projects view of the library of digital images. In addition, if the folders which are stored at the first selected hierarchy level represent albums and consist of one or more pointers to corresponding digital images, then the method further includes presenting a flat all-albums view of the library of digital images.

According to another aspect, the described subject matter can also be implemented in a system including a storage device configured to store a library including a plurality of media items and folders stored in a hierarchy associated with the library. Types of media items can include digital images, projects and albums. Each project can represent a user-defined set of digital images. Each album can represent a user-defined set of pointers to digital images. The system further includes a processor that is communicatively coupled with the storage device. The processor is configured to receive from a user of the system a request to view media items of a particular type. All the media items of the particular type residing at any location within the hierarchy can be identified by the processor. Further, the processor is configured to present a flat view of all the identified media items of the particular type.

These and other implementations can include one or more of the following features. If the particular type of media specified by the request is a project, the processor is configured to present a flat view of all the identified projects. If the particular type of media specified by the request is an album, the processor is configured to present a flat view of all the identified albums. And, if the particular type of media specified by the request is a digital image, the processor is configured to present a flat view of all the identified digital images. The flat view includes all the identified media items of the particular type grouped into respective folder associations. Additionally, the flat view includes all the identified media items of the particular type grouped into respective year-interval associations. For example, the request received from the user can specify a given location within the hierarchy. Then, the presented flat view includes only those media items of the particular type at or below the given location within the hierarchy.

According to another aspect, the described subject matter can also be implemented in a method including receiving input from a user of an application executing on a computer system to view a set of digital assets stored in at least one digital library accessible by the application. The set of digital assets includes files, containers and folders stored according to a hierarchy corresponding to the at least one digital library. A container can include a plurality of files. An input selecting one of the at least one digital library can be received from the user. Input indicating a particular hierarchy level of the selected digital library can also be received from the user. All containers stored at or below the particular hierarchy level are then identified. A flat view of all the identified containers can be presented by the application.

These and other implementations can include one or more of the following features. In some implementations, the selected digital library can represent a database that stores the set of digital assets in logical folders. The containers can represent projects, such that each project includes a user-defined set of files, and the folders represent logical folders. In these implementations, the projects and the logical folders are stored according to a logical hierarchy corresponding to the database. The flat view of all the identified projects contained in the database can be depicted by the application.

In some implementations, the selected digital library can represent a file system on a storage device communicatively coupled with the computer system. The containers can represent project-folders, such that each project-folder is flat and includes a user-defined set of files, and the folders represent file system directories. In these implementations, the project-folders and the directories are stored according to a directory-tree hierarchy corresponding to the file system. The flat view of all the identified project-folders contained in the file system can be depicted by the application.

Particular aspects of the subject matter described in this specification can be implemented to realize one or more of the potential advantages described below. The processes disclosed in this specification can generate global views to enable efficient browsing of large sets of digital assets. Specifically, the disclosed processes enable the flattening of the hierarchy of projects associated with the library of digital images into a single level. The single level of the all-projects view can be selected by a user and can include projects from all hierarchical levels at and below the selected single level. In instances when the library of digital assets has a deep tree structure, which has multiple leaves, the user can see the projects of the hierarchy without having to drill down to each leaf. Consequently, the user can see all the projects at once, prior to selecting a tree structure path for reducing the all-projects view. Hence, the user can avoid getting lost while navigating through a deep library architecture, and can evaluate the number of projects below a current level of the all-projects view.

Additionally, the user can select grouping criteria for displaying the all-projects view. The flattening of the project hierarchy of the library enables a user to rapidly access and drill into desired projects. Further, a display of a project-based hierarchy (such as the disclosed all-projects-view) can be less visually noisy then a hierarchy of containers.

Details of one or more implementations are set forth in the accompanying drawings and the description below. Other features and advantages will be apparent from the description and drawings, and from the claims.

### DESCRIPTION OF DRAWINGS

FIG. 1 shows a block diagram of an example system including a digital computer in communication with a digital camera and a storage device storing digital images.

FIG. 2 shows a flow chart of an example process for displaying an all-projects view of a library of digital images.

FIG. 3A-C are block diagrams showing aspects of an example implementation of a process for displaying an all-projects view of a library of digital images.

FIGS. 4A-4B are block diagrams showing other aspects of the example implementation illustrated in FIG. 3C of the process for displaying an all-projects view of a library of digital images.

FIG. 5 shows a flow chart of another example process for displaying an all-projects view of a library of digital images.

Like reference symbols in the various drawings indicate like elements.

### DETAILED DESCRIPTION

This specification discloses processes and systems for generating and displaying a flat global view of a library of digital assets that are arranged and stored across multiple hierarchical levels. For example, the techniques and systems disclosed in this specification can be implemented in the APERTURE® software (available from Apple, of Cupertino, Calif.) for browsing large sets of digital images.

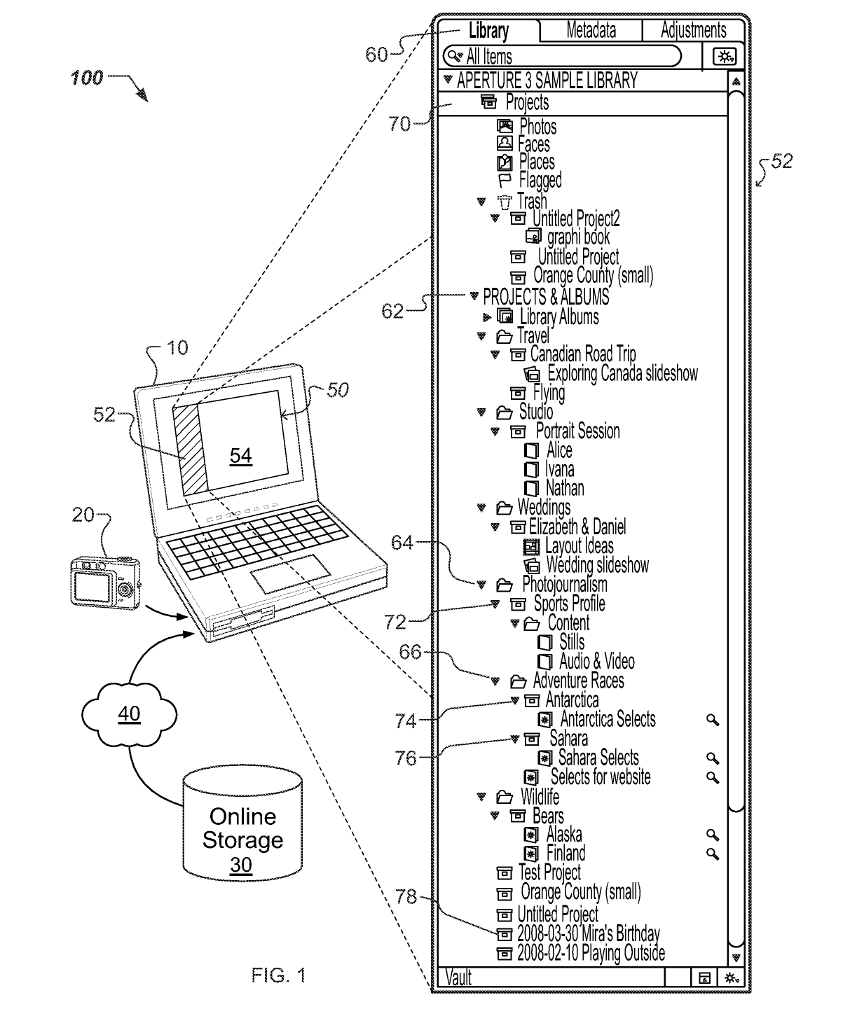

FIG. 1 shows a block diagram of an example system 100 including a digital computer 10 in communication with a digital camera 20 and a storage device 30 storing digital images.

The digital computer 10 can be a laptop computer, a workstation or a server computer. In some implementations, the digital camera 20 and the storage device storing digital images 30 can be coupled to the digital computer 10 using a variety of known technologies (e.g., USB, FireWire®, RS 232). In other implementations, the storage device storing digital images 30 can be located remotely from the digital computer 10 and be operated as part of a cloud service. In such implementations, the digital computer 10 can communicate with the storage device 30 via a communication network 40, e.g., the internet. The connection between the digital computer 10 and the network-based storage device 30 can be implemented as a wired or wireless network connection.

A software interface 50 of an application running on the digital computer 10 is configured to browse through and to display digital images received from the digital camera 20 and the storage device 30. In some implementations, the foregoing digital images may be received automatically, e.g., upon establishing a connection with the digital camera 20 and/or the storage device 30. In addition, the software interface 50 may be configured to receive instructions entered by the user. Such user instructions may be for requesting digital images from the connected digital camera 20 and/or from the storage device storing digital images 30. Other instructions entered by the user to the software interface 50 may be for selecting some or all of the displayed digital images (previously received from the connected devices).

The software interface 50 can include an inspector panel 52 and a viewer panel 54. The inspector panel 52 and the viewer panel 54 may be resizable. The inspector panel includes three tabs: a library tab 60, a metadata tab, and an adjustments tab. The library tab 60 enables a user to select a project to work on.

The library tab 60 displays a hierarchical tree of one or more libraries. An example library 62 illustrated in FIG. 1 is labeled “Projects and Albums”. Within the library, projects can exist at the top hierarchical level of the library. At the top hierarchical level, a library can include projects and folders. One of the projects at the top hierarchical level of example library 62 is labeled “2008-03-30 Mira's Birthday” 78. One of the folders at the top hierarchical level of example library 62 is labeled “Photojournalism” 64.

At the top hierarchical level of a folder there can be projects and subfolders. The top hierarchical level of a folder represents the second hierarchical level of the library. A project at the top hierarchical level of example folder 64 is labeled “Sports Profiles” 72. A subfolder at the top hierarchical level of example folder 64 is labeled “Adventure Races” 66.

At the top hierarchical level of a subfolder there can be projects and subfolders. The top hierarchical level of a subfolder represents the third hierarchical level of the library. The two projects at the top hierarchical level of example subfolder 66 are labeled “Antarctica” 74 and “Sahara” 76, respectively.

In this specification, projects can include digital images. A digital image can be associated with at most one project. In contrast, an album can only reference digital images (e.g., through shortcuts or pointers), therefore a digital image can belong to multiple albums. The digital images that are included in a project need not be grouped. For example, digital images in the project “2008-03-30 Mira's Birthday” 78 are ungrouped. However, digital images that are included in a project can be grouped based on various criteria. For example, the project “Sports Profiles” 72 includes digital images grouped by “Stills” and “Audio & Video”. Further, the project “Antarctica” 74 can include a group of selected digital images.

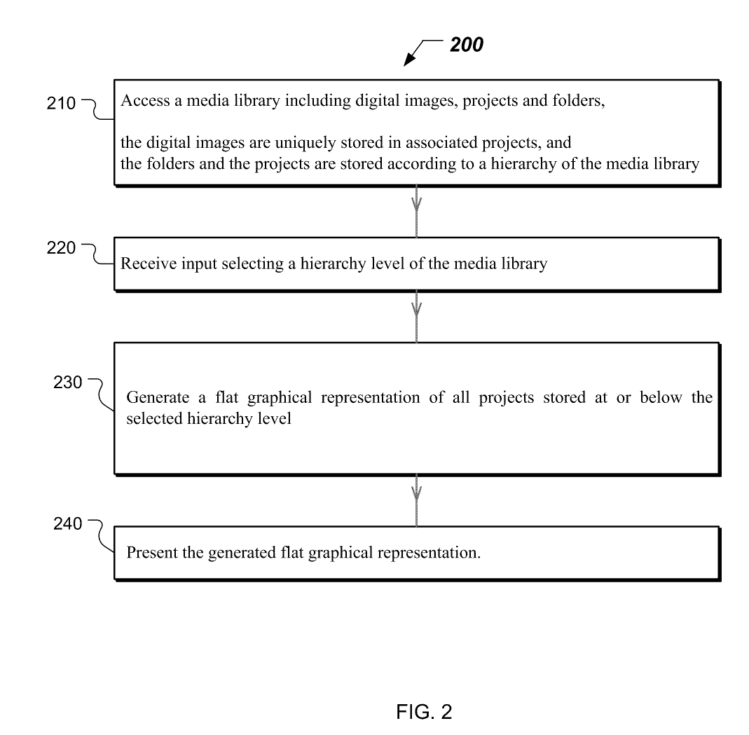

In the library tab 60 of inspector panel 52, projects can be represented graphically by a project symbol 70. However in the viewer panel 54, the projects can be represented graphically by corresponding images. Specifically, a project can be represented graphically by a corresponding image from among the images included in the project. Moreover, the software interface 50 can be configured to display in the viewer 54 various groupings of the projects included in a library of digital images. This specification discloses processes that can be used for generating various views of project groupings and for displaying the generated project groupings in the viewer 54 of the software interface 50. An example of such a process can be implemented in the system 100 as described in reference to FIG. 2.

FIG. 2 shows a flow-chart diagram of an example process 200 implemented on a digital computer 10 for generating views of projects including digital assets. Process 200 can be implemented as part of an application 50 to receive input from a user of the application requesting to view content accessible by the application. The accessible content can include a plurality of digital assets, folders and projects stored in a hierarchy associated with the application 50. As described below, all projects residing at any location within the hierarchy can be identified, and a flat view of all identified projects can be presented. In general, the foregoing digital assets can include media items or other types of electronic documents. In example implementations of process 200 described below in connection with FIGS. 2-5, the media items represent digital images. However, the processes disclosed in this specification can also be applied to digital assets including spreadsheets, word processing documents, and PDF documents.

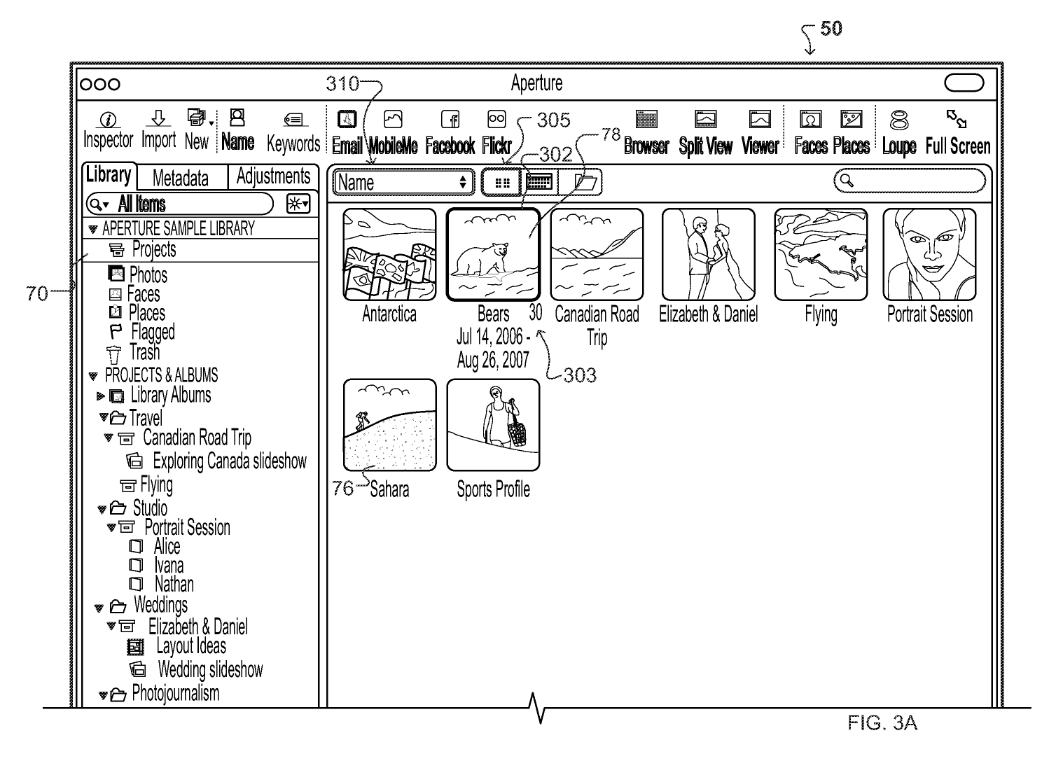

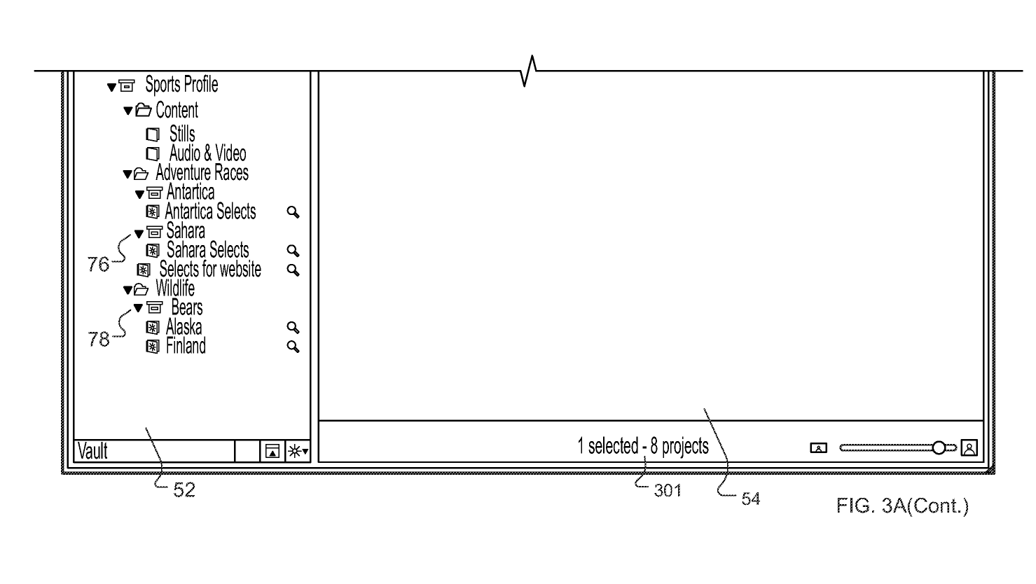

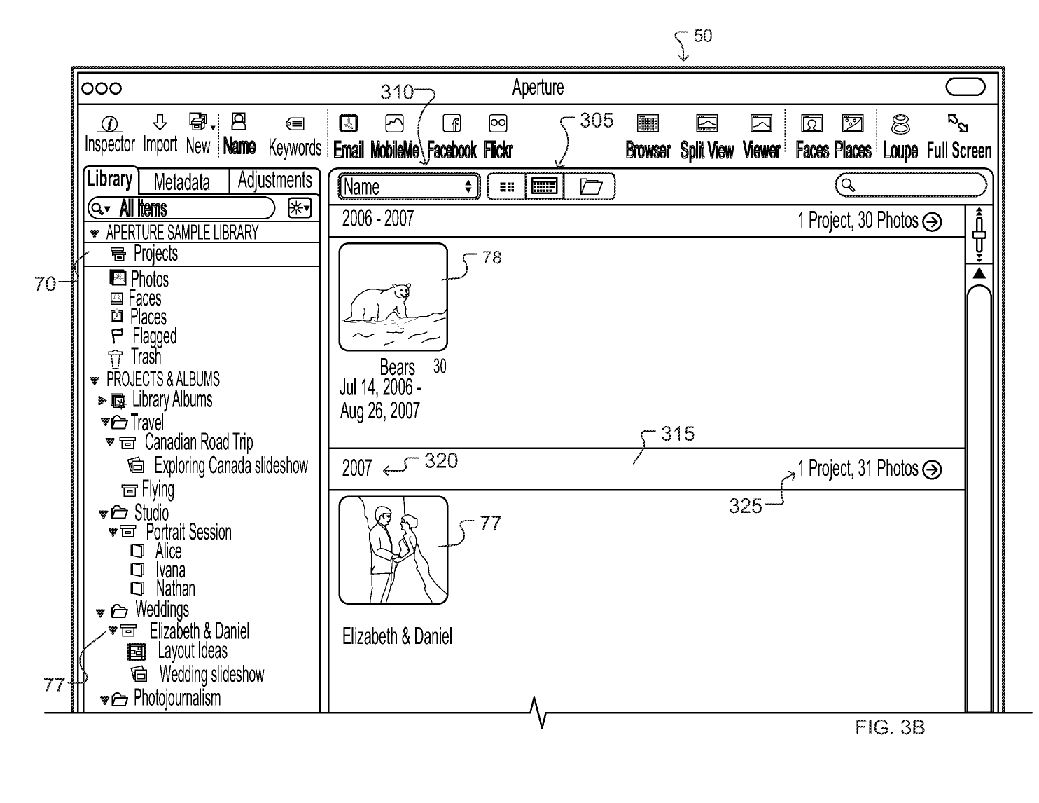

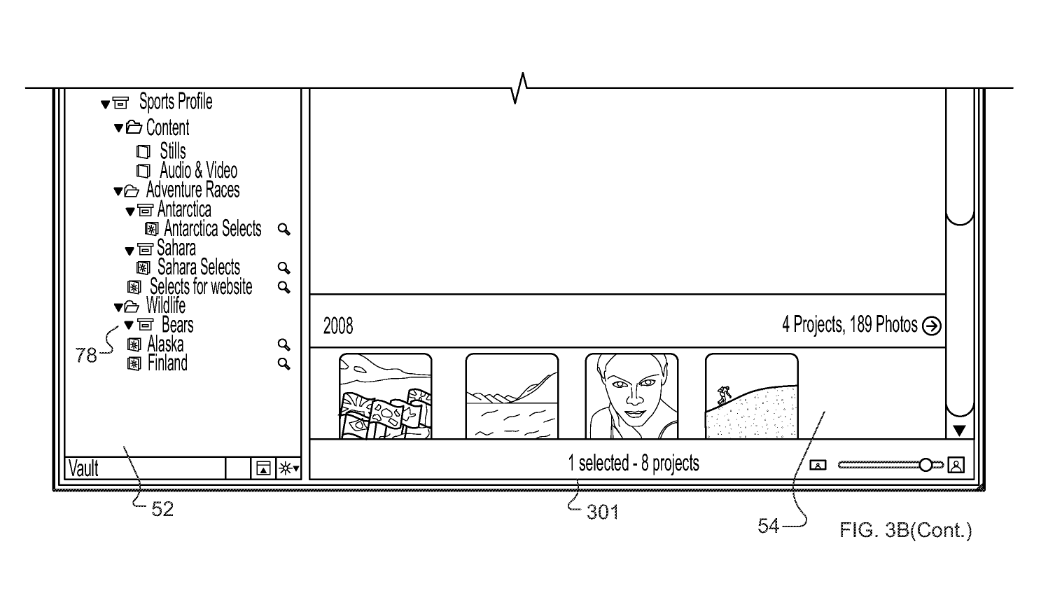

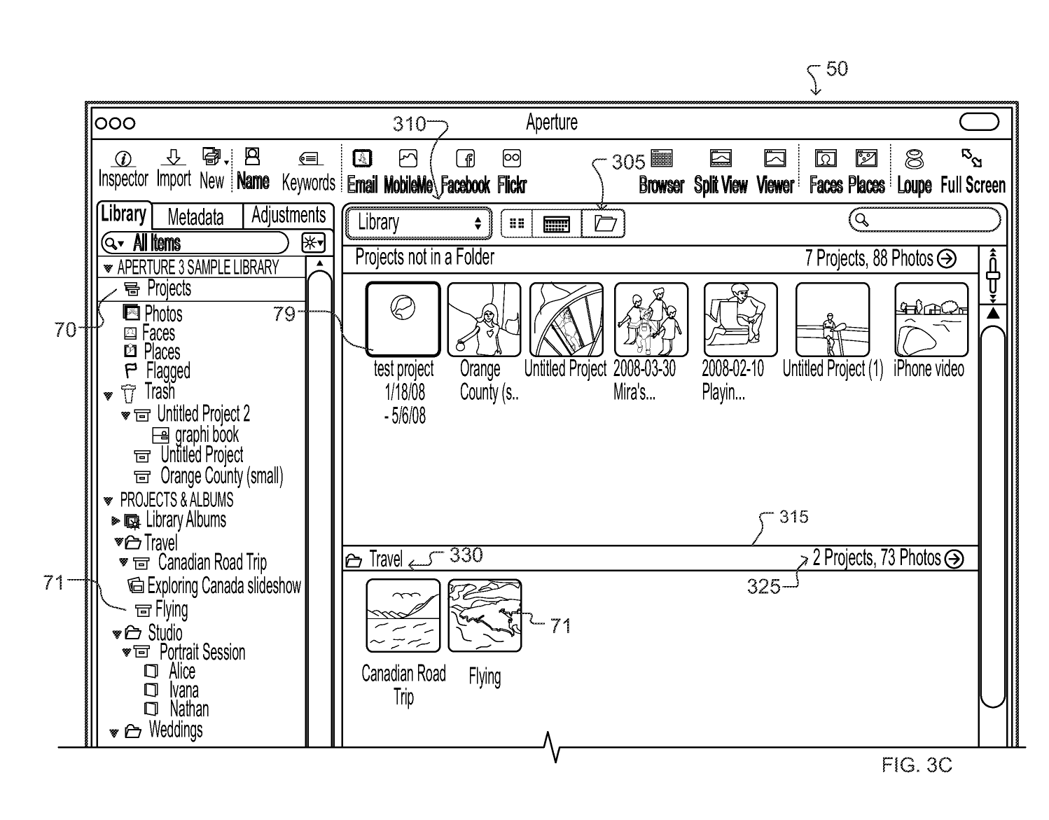

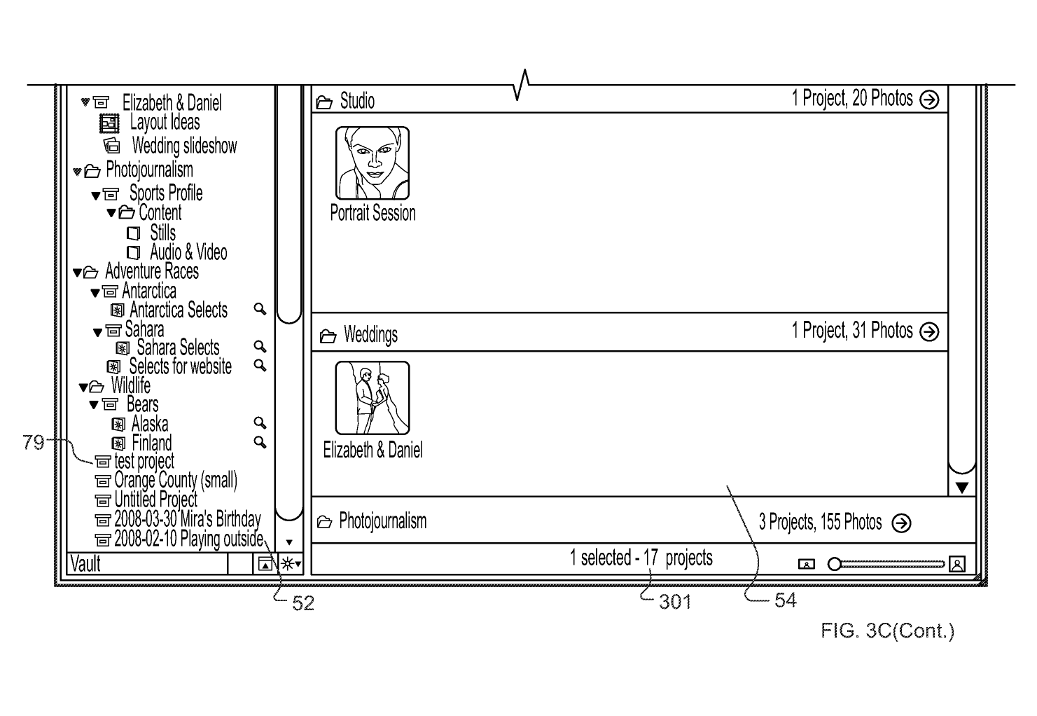

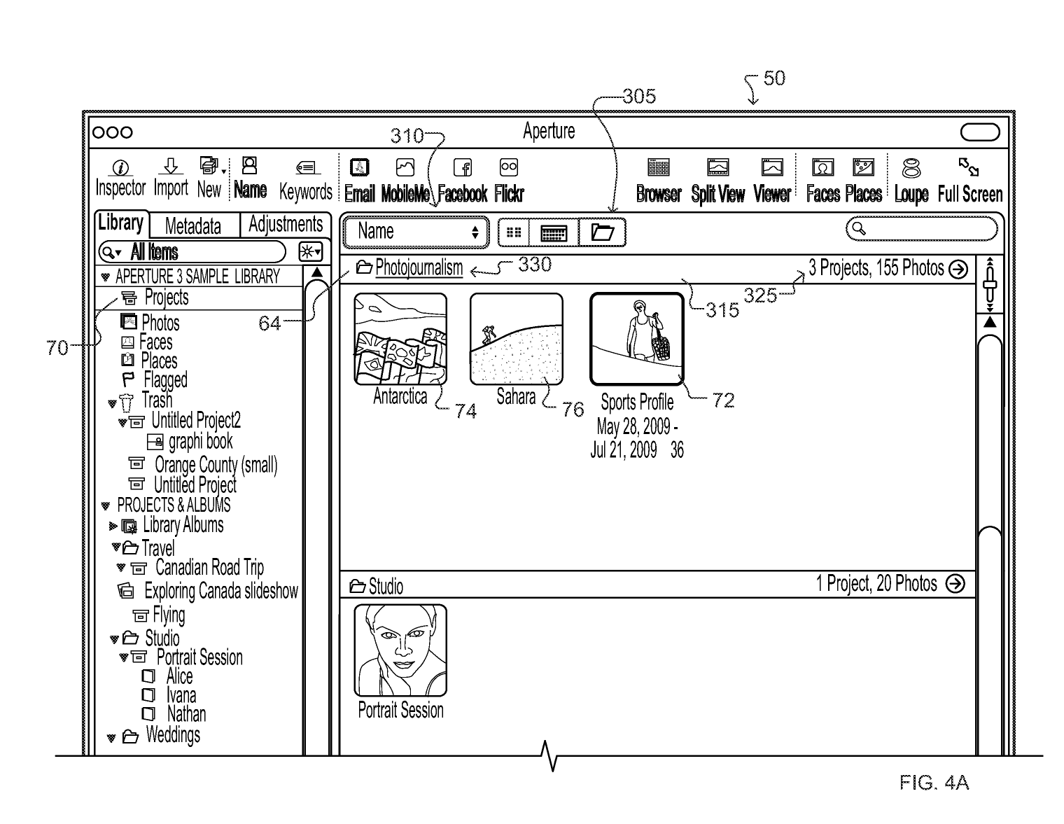

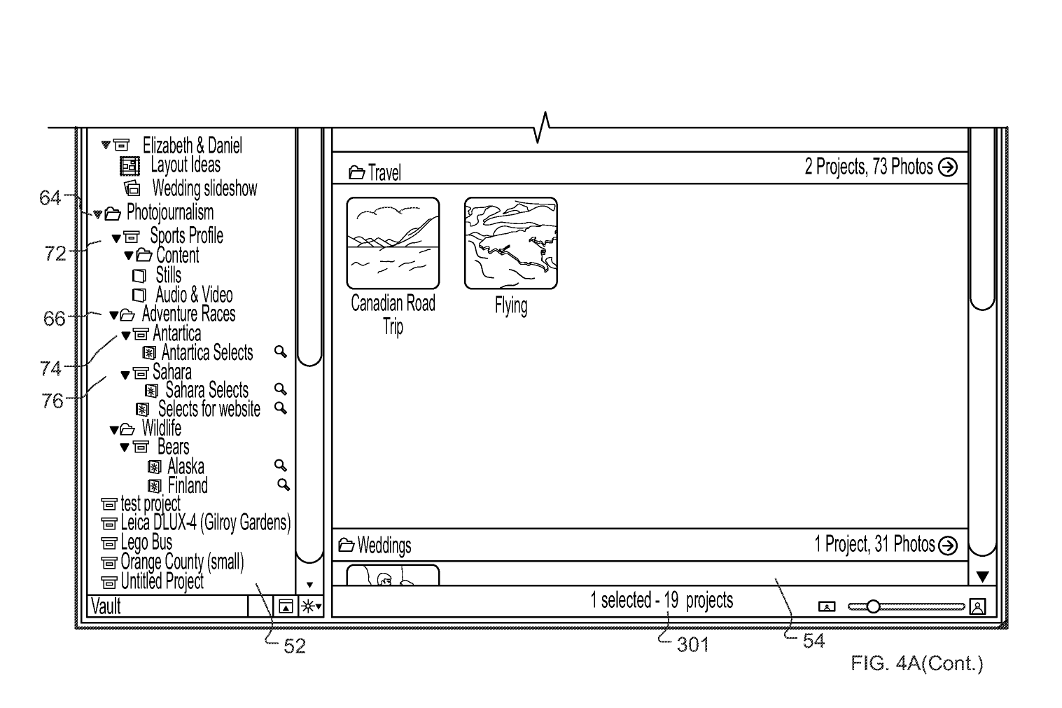

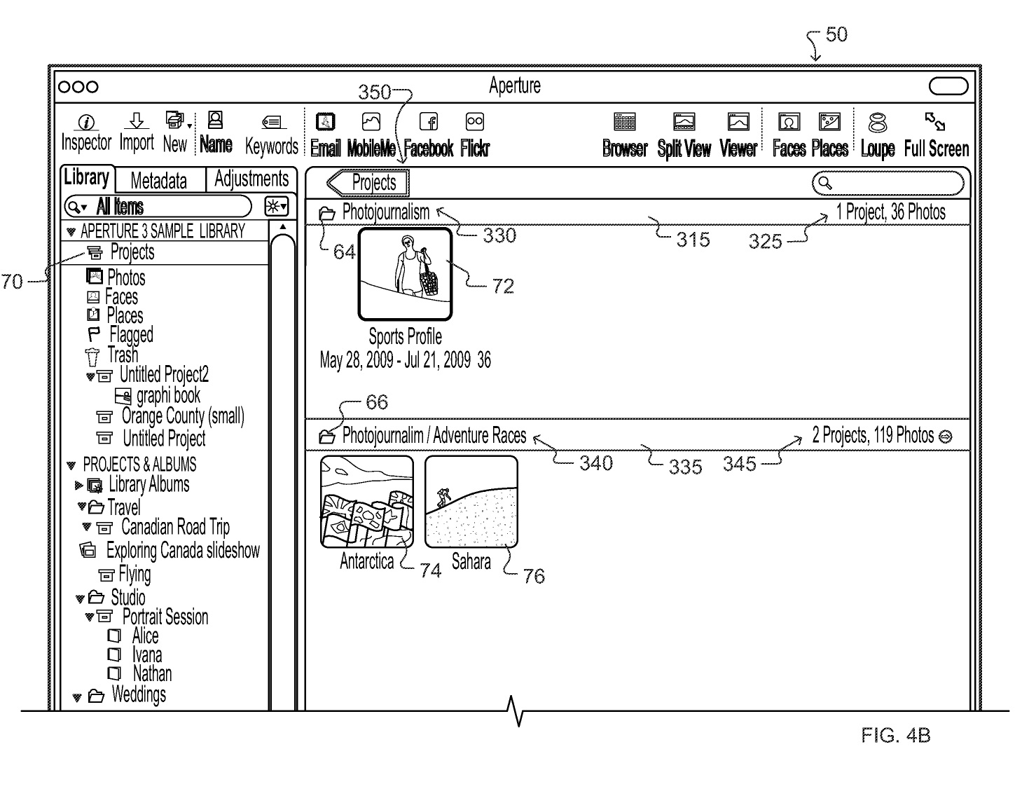

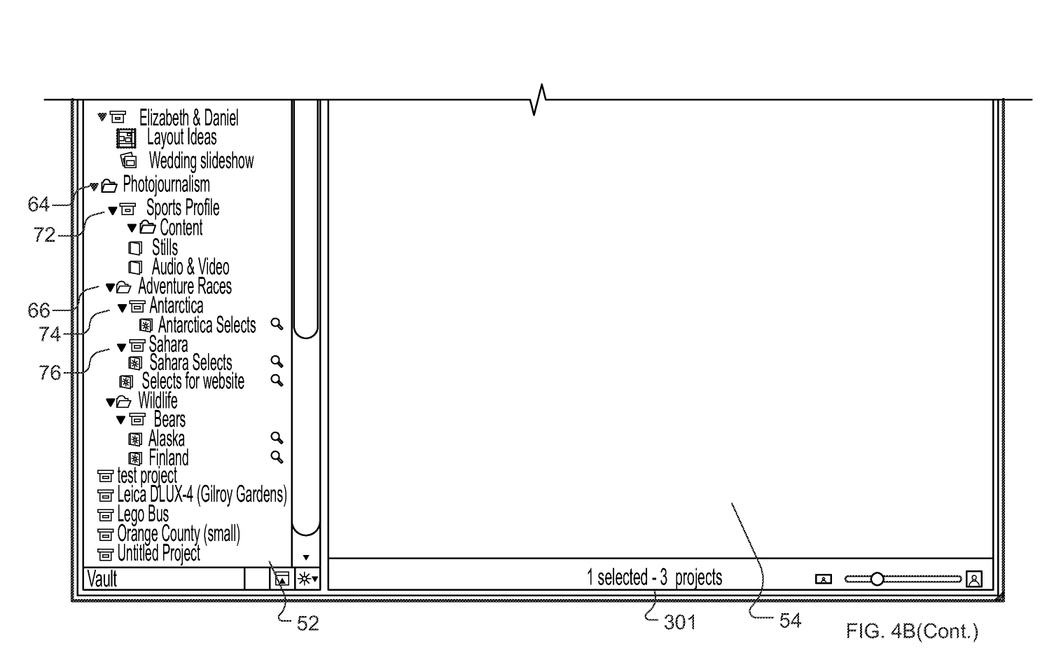

As part of process 200, the digital computer 10 can access (210) a media library including digital images, projects and folders. The digital images are uniquely stored in associated projects, and the folders and the projects are stored according to a hierarchy of the media library. In the example system 100 discussed above in connection with FIG. 1, the library includes projects and folders stored at the top hierarchical level, projects and subfolders stored at a next hierarchical level below the top level, etc. In addition, in the example system 100 each project can be graphically represented by an image included in the project, as disclosed below in reference to FIGS. 3A-4B.

The digital computer 10 can be further configured to receive (220) input selecting a hierarchical level corresponding to the media library. Various ways to provide such input are disclosed below in connection with FIGS. 3A-4B. Moreover, the selected hierarchical levels of the library of digital images can be a library level, a folder level or a subfolder level. Further, the projects displayed at a selected hierarchical level can be grouped by folder, by subfolder or by an acquisition year.

The digital computer can also generate (230) a flat graphical representation of all projects stored at or below the selected hierarchy level. The input received (220) from the user can specify a particular location within the hierarchy and the generated flat graphical representation can include only those projects at or below that selected location within the hierarchy. For example, if the viewer selects to view the projects at folder level, the application flattens the hierarchy by displaying all projects included in a folder at the same level, whether the projects are stored in subfolders of the folder or at the top level of the folder.

Finally, the digital computer 10 can be configured to present (240) the generated flat graphical representation in the view panel 54 of the software interface 50. As disclosed in detail in connection with FIGS. 3A-3C, the flat graphical representation can include all projects at or below the selected hierarchy level arranged in alphabetical order. Additionally, the flat graphical representation can contain all projects at or below the selected hierarchy level grouped into respective folder associations or grouped into respective date associations.

FIG. 3A shows an example implementation of process 200 for configuring the software interface 50 to display an all-projects view in the viewer panel 54. The all-projects view includes graphical representations corresponding to projects stored in the library of digital images without reference to the various hierarchical levels of the projects (e.g., folders, subfolders, etc.). For example, the project labeled “Sahara” 76 is represented graphically by a project-icon in the inspector panel 52, and by a corresponding image from the “Sahara” project in the viewer panel 54. The absence of any reference to the subfolder “Adventure Races” of the folder “Photojournalism” from the graphical representation of the “Sahara” project in the viewer panel 54 determines at least in part the flattened hierarchy of the all-projects view. In accordance with process 200, all the projects included in the library of digital images can be represented graphically by the hierarchically flattened all-projects view. In the example implementation illustrated in FIG. 3A, the inspector 52 shows the hierarchical tree of a library of digital images that includes eight projects. Label 301 of the software interface 50 indicates that all eight projects included in the library of digital images are part of the all-projects view displayed in the viewer panel 54.

The all-projects view can be generated in response to a user selecting the projects icon 70 in the inspector panel 52. Additionally, the user can select from control 305 the grouping criterion to be applied for presenting the generated all-projects view. The grouping criterion 305 selected in the example implementation illustrated in FIG. 3A corresponds to a grid. The grid can group together all projects included in the library of digital images, and can flatten the hierarchy of the library of digital images. Additionally, the projects displayed in the all-projects view can also be grouped by a range of acquisition times corresponding to digital images included in projects (as discussed in connection with FIG. 3B), or can be grouped by folder (discussed in connection with FIG. 3C). In addition, the user can select from control 310 a sorting criterion to sort the generated grid. The projects displayed in the grid can be sorted by one of: library, name (ascending or descending) and acquisition time (ascending or descending). In the example implementation illustrated in FIG. 3A, the projects in the grid are sorted by name (ascending).

Label 301 of the software interface 50 can also indicate whether one or more projects are being selected. A selected project image can have a highlighted perimeter. Additionally, a selected project can have an accompanying selection-label that contains additional information relating to the digital images included in the selected project. In the example implementation illustrated in FIG. 3A, the graphical representation of the “Bears” project 78 in the all-projects view is selected. The selection is represented by a highlighted perimeter 302 around the corresponding image from the “Bears” project 78, and by a selection-label 303 that contains information about the total number and the acquisition time range of the digital images included in the “Bears” project 78. Specifically, there are 30 digital images in the “Bears” project 78. Further, the digital images included in the “Bears” project 78 have been acquired in the calendar date range starting Jul. 14, 2006 and ending Aug. 26, 2007. Finally, clicking on a selected project can replace the all-projects view with a single-project view in the viewer panel 54 of the software interface 50. The single-project view may include a digital image viewer panel and a project browser panel.

FIG. 3B shows another example implementation of process 200 for configuring the software interface 50 to display an all-projects view in the viewer panel 54. The all-projects view can be generated in response to a selection of the projects icon 70 in the inspector panel 52, and a selection, from control 305, of the grouping criterion to be applied. The grouping criterion 305 selected in the example implementation illustrated in FIG. 3B corresponds to a calendar range. The calendar range for a project is defined as a calendar interval that starts at a date corresponding to the first acquired digital image of the project, and ends at a date corresponding to the last acquired digital image of the project. A project for which the calendar range is contained within a calendar year can be displayed in a group corresponding to the calendar year. In the example implementation illustrated in FIG. 3B, the digital images included in the project labeled “Elizabeth & Daniel” 77 were acquired during 2007. Therefore, the “Elizabeth & Daniel” project 77 is displayed as part of the calendar group labeled “2007”. Further, there are four projects in the calendar group labeled “2008”, as the associated calendar range for each of the four projects is contained within the year 2008.

However, a project for which the calendar range extends over two or more calendar years can be displayed in a group corresponding to a range of the two or more years. In the example implementation illustrated in FIG. 3B, the digital images included in the project labeled “Bears” 78 were acquired between Jul. 14, 2006 and Aug. 26, 2007. Therefore, the “Bears” project 78 is displayed as part of the calendar group labeled “2006-2007”. Calendar groups “2006-2007”, “2007”, “2008”, . . . are part of the all-projects view in the viewer panel 54 of software interface 50.

The projects displayed within a calendar group can be sorted by name (ascending or descending) or by acquisition time (ascending or descending). In the example implementation illustrated in FIG. 3B, the projects in each calendar group are sorted by name (ascending).

Each of the calendar groups are displayed below a corresponding horizontal bar 315 that separates a calendar group from the preceding calendar group. In addition, the horizontal bar of a calendar group can include a calendar label 320 denoting the respective calendar year. Further, the horizontal bar of the calendar group can also include a group statistics label 325 containing an indication of the total number of projects and total number of digital images included in the calendar group. For example, in the implementation illustrated in FIG. 3B, the calendar label 320 corresponding to the project labeled “Elizabeth & Daniel” 77 is “2007”. Further, the calendar group “2007” includes 1 project and 31 photos, as indicated in the group statistics label 325.

Finally, projects included in the library of digital images and grouped within each calendar group are displayed in the viewer panel 54 of the software interface 50 according to the flattened hierarchy of the all-projects view. Consequently, the total number of projects displayed in the all-project view (as indicated in label 301) is the sum of the projects from each of the calendar groups. In the example implementation illustrated in FIG. 3B, label 301 indicates that there are 8 projects displayed in the all-projects view. The projects from groups “2006-2007”, “2007”, “2008”, . . . also add up to 8 projects.

FIG. 3C shows an additional example implementation of process 200 for configuring the software interface 50 to display an all-projects view in the viewer panel 54. The all-projects view can be generated in response to a selection of the projects icon 70 in the inspector panel 52, and a selection, from control 305, of the grouping criterion to be applied. The grouping criterion 305 selected in the example implementation illustrated in FIG. 3C corresponds to a folder. A project contained in a certain library folder is being grouped in the all-projects view together with other projects from that library folder. In the example implementation illustrated in FIG. 3C, the project labeled “Flying” 71 is stored in the folder labeled “Travel” and displayed in the folder group labeled “Travel”. However, the project labeled “test project” 79 is stored at the top level of the library “Projects & Albums”. Therefore, the “test project” 79 is displayed in a folder group labeled “Projects not in a Folder”.

The projects displayed within a folder group can be sorted by name (ascending or descending) or by acquisition time (ascending or descending). In the example implementation illustrated in FIG. 3C, the projects in each folder group are sorted by library.

Each of the folder groups are displayed below a corresponding horizontal bar 315 that separates a folder group from the preceding folder group. In addition, the horizontal bar 315 of a folder group can include a folder label 330 denoting the respective folder name. Further, the horizontal bar 315 of the folder group can also include a group statistics label 325 containing an indication of the total number of projects and total number of digital images included in the folder group. For example, in the example implementation illustrated in FIG. 3C, the folder label 330 corresponding to the project labeled “Flying” 71 is “Travel”. Further, the folder group “Travel” includes 2 projects and 73 photos, as indicated in the group statistics label 325.

Finally, projects included in the library of digital images and grouped within each folder group are displayed in the viewer panel 54 of the software interface 50 according to the flattened hierarchy of the all-projects view. Consequently, the total number of projects displayed in the all-project view (as indicated in label 301) is the sum of the projects from each of the folder groups. In the example implementation illustrated in FIG. 3C, label 301 indicates that there are 17 projects displayed in the all-projects view. The projects from groups “Projects not in a Folder”, “Travel”, “Studio”, . . . also add up to 17 projects.

FIG. 4A shows another aspect of the example implementation described above in connection with FIG. 3C. For example, the all-projects view can be generated in response to a user selecting the projects icon 70 in the inspector panel 52, and the group-by-folder criterion from control 305. The projects within each folder group are displayed in the viewer panel 54 of the software interface 50 according to the flattened hierarchy of the all-projects view. The all-projects view includes graphical representations corresponding to projects stored in the library of digital images without reference to the various hierarchical levels of the projects (e.g., folders, subfolders, etc.).

In the example implementation illustrated in FIG. 4A, the project labeled “Sports Profile” 71 is stored in the folder labeled “Photojournalism” 64 and displayed in the folder group labeled “Photojournalism” 330. The projects labeled “Antarctica” 74 and “Sahara” 76 are stored in the subfolder “Adventure Races” 66 of the folder “Photojournalism” 64 and are displayed in the folder group “Photojournalism” 330. The fact that the projects “Antarctica” 74, “Sahara” 76 and “Sports Profile” 71 are displayed at the same level within the folder group “Photojournalism” 330 is a feature of the flattened hierarchy of the all-projects view. Further in the example implementation illustrated in FIG. 4A, the projects in each folder group are sorted by name as indicated by control 310.

As discussed above, the horizontal bar 315 of a folder group, that separates a folder group from the preceding folder group, can include a folder label 330 and group statistics label 325. In some implementations, the labels 325 and 330 can provide navigation controls to a hierarchical level below the flattened hierarchical level corresponding to the all-projects view. Upon a user clicking on either of the labels 325 or 330 of a chosen folder group, the software interface 50 can replace the all-projects view corresponding to the library of digital images with an all-projects view corresponding to the chosen folder. In the example implementation illustrated in FIG. 4A, when a user clicks on label “Photojournalism” 330 or the group statistics label 325, the software interface 50 presents the user with the all-projects view corresponding to the “Photojournalism” folder, as illustrated in FIG. 4B.

FIG. 4B shows an additional aspect of the example implementation described above in connection with FIGS. 3C and 4A. For example, an all-projects view corresponding to a chosen folder can be generated in response to a user clicking either one of the labels 325 or 330 of the chosen folder displayed in an all-projects view (illustrated in FIG. 3C or 4A). A project contained in a certain subfolder of the chosen folder is being grouped in the all-projects view together with other projects from that certain subfolder. In the example implementation illustrated in FIG. 4B, the projects labeled “Antarctica” 74 and “Sahara” 76 are stored in the subfolder labeled “Adventure Races” 66 of folder “Photojournalism” 64, and are displayed in the subfolder group labeled “Photojournalism/Adventure Races” 340. However, the project labeled “Sports Profile” 72 is stored at the top level of the folder “Photojournalism” 64, and does not belong to a subfolder of the “Photojournalism” folder 64. Therefore in the all-projects view, the project “Sports Profile” 72 is displayed under the folder group “Photojournalism” 330.

In analogy to the method of separating the folder groups described above in connection with FIGS. 3C and 4A, each of the subfolder groups are displayed below a corresponding horizontal bar 335 that separates a subfolder group from a preceding subfolder group. In addition, the horizontal bar 335 of a subfolder group can include a subfolder label 340 denoting the respective subfolder and folder names. Further, the horizontal bar 335 of the subfolder group can also include a group statistics label 345 containing an indication of the total number of projects and total number of digital images included in the folder group. For example, in the example implementation illustrated in FIG. 4B, the subfolder label 340 corresponding to the projects “Antarctica” 74 and “Sahara” 76 is “Photojournalism/Adventure Races”. Further, the subfolder group “Photojournalism/Adventure Races” includes 2 projects and 119 photos, as indicated in the group statistics label 345.

In some implementations, the labels 340 and 345 can provide navigation controls to a hierarchical level below the flattened hierarchical level corresponding to the all-projects view. Upon a user clicking on either of the labels 340 and 345 of a certain subfolder group of a chosen folder, the software interface 50 can replace the all-projects view corresponding to the chosen folder with an all-projects view corresponding to the certain subfolder. In addition, a user of the software interface 50 can return from the all-projects view corresponding to the chosen folder to the all-projects view corresponding to the library of digital images by using a navigation command 350.

Finally, projects included in the chosen folder and grouped within each subfolder group are displayed in the viewer panel 54 of the software interface 50 according to the flattened hierarchy of the all-projects view. Consequently, the total number of projects displayed in the all-project view (as indicated in label 301) equals the sum of the projects from each of the subfolder groups. In the example implementation illustrated in FIG. 4B, label 301 indicates that there are 3 projects displayed in the all-projects view. The projects from groups “Photojournalism” and “Photojournalism/Adventure Races” also add up to 3 projects.

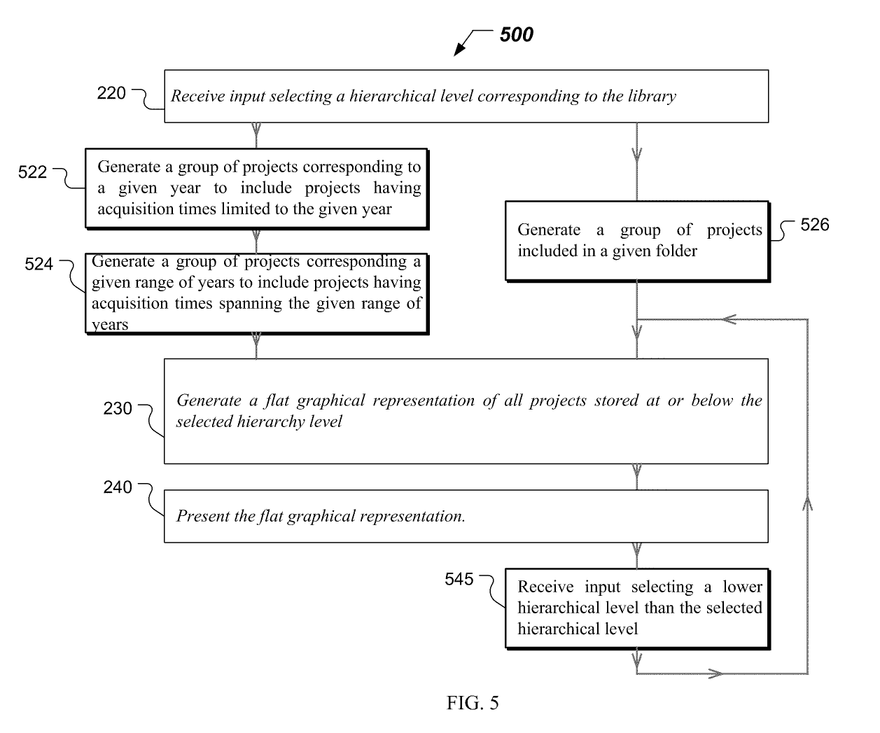

FIG. 5 shows a flow chart diagram of an example process 500 implemented on a digital computer 10 for generating views of projects including digital images. Further, process 500 can be combined with process 200 disclosed above in connection with FIG. 2.

Process 500 can start after receiving (220) input for selecting a hierarchical level corresponding to the library. The digital computer can be configured to generate a group of projects corresponding to a given year to include projects having acquisition times limited to the given year (522). The digital computer can be further configured to generate a group of projects corresponding to a given range of years to include projects having acquisition times that span the given range (524). An example implementation of steps (522) and (524) of process 500 have been described in detail with respect to FIG. 3B.

The computer can also be configured to generate a group of projects contained in a given folder of the library of digital images (526). An example implementation of steps (526) has been described in detail with respect to FIGS. 3C and 4A.

Next, the digital computer can generate (230) a flat graphical representation of all projects stored at or below the selected hierarchy level. For example, if the user selects to view the projects at folder level, the application flattens the hierarchy below folder level by displaying all projects included in a folder at the same level whether the projects are stored in subfolders or at the top level of the folder.

Finally, the digital computer 10 can be configured to receive (545) an input selecting another hierarchical level, lower than the currently selected hierarchical level. For example, the user can select to view the projects at a given subfolder level when the current hierarchical level is a folder that includes the given subfolder.

Upon completion of step (545), process 500 loops back to generating (230) a flat graphical representation of all the projects stored at or below the other selected hierarchical level. For example, if the user selects to view the projects at subfolder level, the application flattens the hierarchy below subfolder level by displaying all projects included in the subfolder at the same level whether the projects are stored in deeper subfolders or at the top level of the subfolder.

The processes disclosed in this specification have been implemented to enable efficient navigation of a library of digital assets that includes hierarchical levels of folders and projects. In general, the disclosed processes can generate a flat all-projects view at a given hierarchy level of a library of digital assets. The flat all-projects view can be configured to contain groups of projects from all hierarchical levels at and below the given level.

For example, system 100 can include a storage device to store a library including a plurality of media items and folders stored in a hierarchy associated with the library. Different types of media items which are included in the library can be digital images, projects and albums. Each project can represent a user-defined set of digital images. Each album can represent a user-defined set of pointers to digital images. The system 100 further includes a processor to execute an application 50 configured to receive from a user of the application a request to view media items of a particular type. All the media items of the particular type which reside at any location within the hierarchy can be identified by the application. Further, the application is configured to present a flat view of all the identified media items of the particular type.

If the particular type of media specified by the request is a project, the processor is configured to present a flat view of all the identified projects, as described in detail in connection with FIGS. 3A-3C. If the particular type of media specified by the request is an album, the processor is configured to present a flat view of all the identified albums. And, if the particular type of media specified by the request is a digital image, the processor is configured to present a flat view of all the identified digital images. The flat view can include all the identified media items of the particular type grouped into respective folder associations, as disclosed in connection with FIG. 3C. Additionally, the flat view can include all the identified media items of the particular type grouped into respective year-interval associations, as disclosed in connection with FIG. 3B. Further, the request received from the user can specify a given location within the hierarchy, as described in connection with FIGS. 4A-4B. Then, the presented flat view includes only those media items of the particular type at or below the given location within the hierarchy.

Implementations of processes 200 and 500 have been described above in connection with libraries which have logical hierarchies corresponding to digital asset databases. The processes disclosed in this specification can also be implemented to enable efficient navigation of a file system. In general, such a process includes receiving input from a user of an application executing on a computer system to view a plurality of file system objects accessible by the application. The plurality of file system objects includes files, folders and pointers stored according to a hierarchy of the file system. Further input selecting first and second hierarchy levels of the file system can be received from the user. All folders stored between the first and second hierarchy levels can be identified by the application. Then, the application can present a flat view of all the identified folders.

In some implementations, the selected second hierarchy level of the file system represents a root level of the file system. Thus, the flat view of all folders contained in the file system above the first selected level can be depicted at the root level of the file system.

In some implementations, the files represent digital images, and the file system represents a library including the digital images. Some folders which are stored at the first selected hierarchy level consist of one or more files (i.e., include neither subfolders nor pointers). Such folders can represent projects. In the foregoing example, the application is configured to present a flat all-projects view of the library of digital images. Some folders which are stored at the first selected hierarchy level consist of one or more pointers to corresponding digital images (i.e., include neither subfolders nor files). Such folders can represent albums. In this example, the application is configured to present a flat all-albums view of the library of digital images.

As described above, processes 200 and 500 can be implemented to efficiently browse a first set of digital assets stored in accordance with a logical hierarchy of a database or to efficiently browse a second set of digital assets stored in accordance with a directory tree hierarchy of a file system. However, the first set of digital assets can be one and the same with the second set of digital assets, and consequently, the foregoing hierarchies correspond to the same set of digital assets. Moreover, the file system hierarchy and the logical hierarchy for the set of digital assets are independent of each other, and therefore, processes 200 and 500 can be implemented to browse both hierarchies for the set of digital assets in the same application. For example, for a set of digital assets including projects of digital images, such an implementation may include generating a database-all-projects-view and a disk-all-projects view.

In another aspect, the processes disclosed above can also be implemented to enable efficient navigation of a returned list of search results. For example, a system search can be based on search criteria including, for example, a desired string that represents all or part of a name of an electronic document, and a given folder (including its subfolders) to perform the search in. An electronic document (which for brevity will simply be referred to as a document) may, but need not, correspond to a file. A document may be stored in a portion of a file that holds other documents, in a single file dedicated to the document in question, or in multiple coordinated files. The foregoing search can return a list having hierarchical levels of search results.

The returned list of search results can be displayed as a flat all-search-results view at a single level of the returned list of search results. The search results can be, for example, documents that include the desired string in the document name. Whether the documents in the returned list are found at the top level of the given folder or at deeper subfolder levels, the documents displayed in the all-search-results view can be listed at the same level.

A combination of processes 200 and 500 can modify the all-search-results view to generate groups of search results. The groups can be generated based on convenient grouping criteria such as a folder where a searched document is stored, or a year when the searched document has been created. Therefore, the combination of processes 200 and 500 can output the flattened all-search-results view of the returned list of search results. The output all-search-results can be configured to contain groups of documents from all hierarchical levels at and below the single level.

A multitude of computing devices may be used to implement the systems and methods described in this document, as either a client or as a server or plurality of servers. A computing device can be implemented in various forms of digital computers, such as laptops, desktops, workstations, personal digital assistants, servers, blade servers, mainframes, and other appropriate computers. Another computing device can be implemented in various forms of mobile devices, such as personal digital assistants, cellular telephones, smartphones, and other similar computing devices. Additionally, computing devices can include Universal Serial Bus (USB) flash drives. The USB flash drives may store operating systems and other applications. The USB flash drives can include input/output components, such as a wireless transmitter or USB connector that may be inserted into a USB port of another computing device. The components described here, their connections and relationships, and their functions, are meant to be exemplary only, and are not meant to limit implementations of the inventions described and/or claimed in this document.

A computing device can include a processor, memory, a storage device, a high-speed interface connecting to memory and high-speed expansion ports. The computing device can further include a low speed interface connecting to a low speed bus and a storage device. Each of the above components can be interconnected using various busses, and may be mounted on a common motherboard or in other manners as appropriate. The processor can process instructions for execution within the computing device, including instructions stored in the memory or on the storage device to display graphical information for a GUI on an external input/output device, such as a display coupled to high speed interface. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory can store information within the computing device. In one implementation, the memory can be a volatile memory unit or units. In another implementation, the memory can be a non-volatile memory unit or units. The memory may also be another form of computer-readable medium, such as a magnetic or optical disk.

The storage device can provide mass storage for the computing device. In one implementation, the storage device may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory, the storage device, or memory on processor.

The high speed controller can manage bandwidth-intensive operations for the computing device, while the low speed controller can manage lower bandwidth-intensive operations. Such allocation of functions is exemplary only. In one implementation, the high-speed controller can be coupled to memory, to a display (e.g., through a graphics processor or accelerator), and to high-speed expansion ports, which may accept various expansion cards. In the implementation, low-speed controller can be coupled to the storage device and the low-speed expansion port. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device may be implemented in a number of different forms. For example, it may be implemented as a standard server, or multiple times in a group of such servers. It may also be implemented as part of a rack server system. In addition, it may be implemented in a personal computer such as a laptop computer. Alternatively, components from computing device may be combined with other components in a mobile device. Each of such devices may contain one or more computing devices or mobile devices, and an entire system may be made up of multiple computing devices and mobile devices communicating with each other.

A mobile device can include a processor, memory, an input/output device such as a display, a communication interface, and a transceiver, among other components. The mobile device may also be provided with a storage device, such as a microdrive or other device, to provide additional storage. Each of the above components is interconnected using various buses, and several of the components may be mounted on a common motherboard or in other manners as appropriate.

The processor can execute instructions within the mobile device, including instructions stored in the memory. The processor of the mobile device may be implemented as a chipset of chips that include separate and multiple analog and digital processors. Additionally, the processor may be implemented using any of a number of architectures. For example, the processor may be a CISC (Complex Instruction Set Computers) processor, a RISC (Reduced Instruction Set Computer) processor, or a MISC (Minimal Instruction Set Computer) processor. The processor may provide, for example, for coordination of the other components of the mobile device, such as control of user interfaces, applications run by the mobile device, and wireless communication by the mobile device.

The processor of the mobile device may communicate with a user through control interface and display interface coupled to a display. The display may be, for example, a Thin-Film-Transistor Liquid Crystal display or an Organic Light Emitting Diode display, or other appropriate display technology. The display interface may include appropriate circuitry for driving the display to present graphical and other information to a user. The control interface may receive commands from a user and convert them for submission to the processor of the mobile device. In addition, an external interface may provide in communication with processor of the mobile device, so as to enable near area communication of the mobile device with other devices. The external interface may provide, for example, for wired communication in some implementations, or for wireless communication in other implementations, and multiple interfaces may also be used.

The memory stores information within the computing mobile device. The memory can be implemented as one or more of a computer-readable medium or media, a volatile memory unit or units, or a non-volatile memory unit or units. An expansion memory may also be provided and connected to the mobile device through an expansion interface, which may include, for example, a SIMM (Single In Line Memory Module) card interface. Such expansion memory may provide extra storage space for the mobile device, or may also store applications or other information for the mobile device. Specifically, expansion memory may include instructions to carry out or supplement the processes described above, and may include secure information also. Thus, for example, expansion memory may be provide as a security module for the mobile device, and may be programmed with instructions that permit secure use of device. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory, expansion memory, or memory on processor that may be received, for example, over transceiver or external interface.

The mobile device may communicate wirelessly through communication interface, which may include digital signal processing circuitry where necessary. Communication interface may provide for communications under various modes or protocols, such as GSM voice calls, SMS, EMS, or MMS messaging, CDMA, TDMA, PDC, WCDMA, CDMA2000, or GPRS, among others. Such communication may occur, for example, through a radio-frequency transceiver. In addition, short-range communication may occur, such as using a Bluetooth, WiFi, or other such transceiver (not shown). In addition, GPS (Global Positioning System) receiver module may provide additional navigation- and location-related wireless data to the mobile device, which may be used as appropriate by applications running on the mobile device.

The mobile device may also communicate audibly using audio codec, which may receive spoken information from a user and convert it to usable digital information. Audio codec may likewise generate audible sound for a user, such as through a speaker, e.g., in a handset of the mobile device. The sound may include sound from voice telephone calls, may include recorded sound (e.g., voice messages, music files, etc.) and may also include sound generated by applications operating on the mobile device.

The mobile computing device may be implemented in a number of different forms. For example, it may be implemented as a cellular telephone. It may also be implemented as part of a smartphone, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by an application executing on a computer system, the method comprising:
receiving input from a user of the application requesting to view content accessible by the application, the accessible content including a plurality of digital assets, folders and projects stored in a hierarchy accessed by the application, each project representing a user-defined set of digital assets;
identifying all projects residing at any location within the hierarchy; and
presenting a flat view of all identified projects.

2. The method of claim 1, wherein the flat view comprises all identified projects arranged in alphabetical order.

3. The method of claim 1, wherein the flat view comprises all identified projects grouped into respective folder associations.

4. The method of claim 1, wherein the flat view comprises all identified projects grouped into respective date associations.

5. The method of claim 1, wherein the input received from the user specifies a particular location within the hierarchy and the presented flat view includes only those projects at or below that particular location within the hierarchy.

6. The method of claim 1, wherein a digital asset comprises a media item.

7. The method of claim 6, wherein the media item comprises a digital image including either an individual still image or a frame of a movie.

8. The method of claim 1, wherein a digital asset comprises an electronic document.

9. The method of claim 1, wherein the content accessible by the application is stored in a database in accordance with a logical hierarchy, the method further comprising:
presenting the flat view of all identified projects included in the database.

10. The method of claim 1, wherein the content accessible by the application is stored in a file system in accordance with a directory-tree hierarchy, the method further comprising:
presenting the flat view of all identified projects included in the file system.

11. A computer readable medium encoded with a computer program, the program comprising instructions that when executed by a processor of a computing device cause the processor to perform operations comprising:
accessing a media library including digital images, projects and folders, wherein the digital images are uniquely stored in associated projects, and wherein the folders and the projects are stored according to a hierarchy of the media library;
receiving input selecting a hierarchy level of the media library;
generating a flat graphical representation of all projects stored at or below the selected hierarchy level; and
presenting the flat graphical representation.

12. The computer readable medium of claim 11, wherein the instructions, when executed prior to presenting the flat graphical representation, cause the processor to perform further operations comprising:
receiving a grouping criterion; and
grouping projects at or below the selected hierarchy level based on the received grouping criterion.

13. The computer readable medium of claim 12, wherein the received grouping criterion comprises a calendar interval, and wherein the calendar interval corresponding to a project starts on an acquisition date of a first acquired digital image of the project and ends at an acquisition date of a last acquired digital image of the project, and wherein the instructions, when executed to perform the grouping, cause the processor to perform further operations comprising:
generating a group of projects labeled by year to include projects that have calendar ranges contained within the year; and
generating a group of projects labeled by a range of years to include projects that have calendar intervals extended over the range of years.

14. The computer readable medium of claim 12, wherein the received grouping criterion comprises a hierarchy sublevel of the media library, and wherein the instructions, when executed to perform the grouping, cause the processor to perform further operations comprising:
generating a group of projects to include all projects contained at or below the hierarchy sublevel.

15. The computer readable medium of claim 14, wherein the hierarchical sublevel comprises a folder of the media library, wherein the instructions when executed cause the processor to perform further operations comprising:
labeling the generated group of projects in accordance with a folder's name.

16. A system comprising:
a storage device for storing a library of digital assets, wherein the library of digital assets includes folders, projects and digital assets, wherein the digital assets are stored in corresponding user-defined projects, and wherein the folders and the projects are stored according to a hierarchy of the library of digital assets; and
a computing device communicatively coupled with the storage device, wherein the computing device executes an application, and wherein the application is configured to perform operations comprising:
retrieving from the storing device the library of digital assets;
receiving a selection of a hierarchy level of the retrieved library of digital assets;
receiving a grouping criterion;
creating groups of projects based on the received grouping criterion; and
displaying a flat all-projects-view including the created groups of projects stored at or below the selected hierarchy level.

17. The system of claim 16, wherein the received grouping criterion comprises a calendar interval, wherein the calendar interval corresponding to a project starts on a date when a first digital asset of the project is created, and ends on a date when a last digital asset of the project is created, wherein to create the group of projects the application is configured to perform operations comprising:
generating a group of projects labeled by a predetermined calendar range to include projects that have calendar intervals contained within the predetermined calendar range.

18. The system of claim 16, wherein after displaying the flat all-projects-view, the application is further configured to perform operations comprising:
receiving input selecting another hierarchical level of the library of digital assets that is lower than the selected hierarchical level.

19. The system of claim 18, wherein the application comprises a graphical user interface including an input control, wherein the input control comprises one of a menu item, a label, and a button, and wherein the application is configured to receive from a user input selecting the hierarchical level of the library of digital assets via the input control of the user interface.

20. A method comprising:
receiving input from a user of an application executing on a computer system to view a plurality of file system objects accessible by the application, wherein the plurality of file system objects includes files, folders and pointers stored according to a hierarchy of the file system;
receiving input selecting a first and second hierarchy levels of the file system;
identifying all folders stored between the first and second hierarchy levels; and
presenting a flat view of all the identified folders.

21. The method of claim 20, wherein the selected second hierarchy level of the file system represents a root level of the file system, the method further comprising:
depicting, at the root level of the file system, the flat view of all folders contained in the file system above the first selected level.

22. The method of claim 21, wherein the files represent digital images and the file system represents a library including the digital images, and wherein the folders which are stored at the first selected hierarchy level represent projects and consist of one or more files, the method further comprising:
presenting a flat all-projects view of the library of digital images.

23. The method of claim 21, wherein the files represent digital images and the file system represents a library of digital images, and wherein folders which are stored at the first selected hierarchy level represent albums and consist of one or more pointers to corresponding digital images, the method further comprising:
presenting a flat all-albums view of the library of digital images.

24. A system comprising:
a storage device configured to store a library including a plurality of media items and folders stored in a hierarchy associated with the library, wherein types of media items include digital images, projects and albums, each project representing a user-defined set of digital images, and each album representing a user-defined set of pointers to digital images;
a processor that is communicatively coupled with the storage device and that is configured to perform operations comprising:
receiving from a user of the system a request to view media items of a particular type;
identifying all the media items of the particular type residing at or below any location within the hierarchy; and
presenting a flat view of all the identified media items of the particular type.

25. The system of claim 24, wherein:
if the particular type of media item specified by the request is a project, the processor is configured to present a flat view of all the identified projects,
if the particular type of media item specified by the request is an album, the processor is configured to present a flat view of all the identified albums, and
if the particular type of media item specified by the request is a digital image, the processor is configured to present a flat view of all the identified digital images.

26. The system of claim 25, wherein the flat view comprises all the identified media items of the particular type grouped into respective folder associations.

27. The system of claim 25, wherein the flat view comprises all the identified media items of the particular type grouped into respective year-interval associations.

28. The system of claim 25, wherein the request received from the user specifies a given location within the hierarchy and the presented flat view includes only those media items of the particular type at or below the given location within the hierarchy.

29. A method comprising:
receiving input from a user of an application executing on a computer system to view a set of digital assets stored in at least one digital library accessible by the application, wherein the set of digital assets includes files, containers and folders stored according to a hierarchy corresponding to the at least one digital library, wherein a container comprises a plurality of files;
receiving input selecting one of the at least one digital library;
receiving input indicating a particular hierarchy level of the selected digital library;
identifying all containers stored at or below the particular hierarchy level; and
presenting a flat view of all the identified containers.

30. The method of claim 29, wherein the selected digital library represents a database that stores the set of digital assets in logical folders, wherein the containers represent projects, wherein each project includes a user-defined set of files, wherein the folders represent logical folders, and wherein the projects and the logical folders are stored according to a logical hierarchy corresponding to the database, the method further comprising:
depicting the flat view of all the identified projects contained in the database.

31. The method of claim 29, wherein the selected digital library represents a file system on a storage device communicatively coupled with the computer system, wherein the containers represent project-folders, wherein each project-folder is flat and includes a user-defined set of files, wherein the folders represent file system directories, and wherein the projects-folders and the directories are stored according to a directory-tree hierarchy corresponding to the file system, the method further comprising:
depicting the flat view of all the identified project-folders contained in the file system.
